(19) United States
(12) Patent Application Publication
(10) Pub. No.: US 2014/0341684 A1
(43) Pub. Date: Nov. 20, 2014

(54) Whole Cane Storage and Handling System and Method

(71) Applicants: Jon Bradley Hochalter, Stillwater, MN (US); Stephen Michael Holly, Crosslake, MN (US)

(72) Inventors: Jon Bradley Hochalter, Stillwater, MN (US); Stephen Michael Holly, Crosslake, MN (US)

(21) Appl. No.: 14/280,565

(22) Filed: May 16, 2014

Related U.S. Application Data
(60) Provisional application No. 61/824,361, filed on May 16, 2013.

(51) Int. Cl. A01F 25/18; B65G 3/04; A01F 25/22

(52) U.S. Cl. CPC A01F 25/186; A01F 25/22; B65G 3/04
USPC 414/287

(57) ABSTRACT

A whole cane sweet sorghum storage and handling system and method is described. The system and method places leaf-stripped whole cane stalks onto a storage pile which is ventilated to control conditions that prevent the deterioration of sugars in storage, which allows the production of sweet sorghum to ethanol after the harvesting season. The system and method comprises a crane system for transferring the oriented cane either from the transport wagons or dump pile to the storage pile and a long concrete pathway. The cane may be further cleaned of leaves, seed heads, dirt and foreign objects. Cane is deposited on a concrete slab on which airflow conduits have been laid with fans providing airflow. Thermocouples monitor pile conditions.

### CROSS-REFERENCE TO RELATED APPLICATION

This application claims the benefit of U.S. Provisional Application No. 61/824,361 filed on 16 May, 2013, the contents of which are incorporated herein by reference. A claim of priority is made.

### FIELD OF THE INVENTION

The present invention relates to the art of storing sweet sorghum stalks and more particularly to a novel apparatus and method of placing leaf stripped whole stalk sweet sorghum stalks onto a storage pile employing a novel assembly of modified sugar cane handling equipment.

### BACKGROUND OF THE INVENTION

Heretofore, sweet sorghum stalks have not been placed into multi-month storage facilities, but rather transported directly to a facility where processing occurs within hours or days. Such methods create a number of problems including, but not limited to, high capital costs resulting from plant processing facilities operating only 2 months out of the year instead of full capacity, thereby leading to the high costs of the final products.

The storage pile of sweet sorghum whole cane allows for the storage of sweet sorghum over the winter months which will allow for a continuous flow of sweet sorghum whole cane from the storage pile to the processing plant.

Without a suitable storage method, there would be no fuel from the sweet sorghum industry in the northern climates because the harvest season is only 1 or 2 months, and without storage, the processing plant would only operate for 2 months which is not economical. By having a storage method to store the feed-stock, the plant can now operate maybe 6 months instead of 1 or 2 months because the plant has a continuous supply of feed-stock over the winter months making the plant much more profitable.

The sweet sorghum industry has heretofore believed that sweet sorghum could not be stored while maintaining its ethanol-producing qualities. For example, in the 1970's and 1980's sweet sorghum was grown extensively in Romania, but since no one could figure out how to store the sweet sorghum over the winter months so that the processing plant had a continuous supply of feed, sweet sorghum was phased out.

The potential to develop fuel from sweet sorghum has long been known, but without a storage method for northern climates, the industry remains underdeveloped. A need exists for a sweet sorghum storage method that retains its fuel-producing properties. The present invention provides a solution to these needs and other problems, and offers other advantages over the prior art.

### BRIEF SUMMARY OF THE INVENTION

With the foregoing in mind, the present invention provides a novel system, method, and apparatus for effectively placing clean, whole stalk sweet sorghum onto a storage pile for later processing at an appropriate storage facility. The present invention utilizes the ability of sweet sorghum stalk sugars to store under cold conditions and the ability of sweet sorghum stalks to maintain their integrity under piling conditions to allow for the delivery to the processing plant in an undamaged condition. Additionally, rocks, dirt and foreign materials may be excluded by employing a cane cleaning table or a vibrating conveyor/elevator system, to scrub the harvested cane before the stocks are placed on the pile, rather than at the processing plant. The result is the delivery of sweet sorghum stalks ready for processing over many winter months.

An objective of the present invention is to provide a novel apparatus, system and method for placing cleaned, whole stalk sweet sorghum stalks onto a storage pile that will retain the stalks in processing condition throughout non-harvesting months. This system and method retards deterioration of sugars that would render the stalks useless.

Other objectives of the present invention include:
storing cleaned, whole stalk sweet sorghum on a storage pile for later processing, minimizing stalk damage and reducing manufacturing costs by increasing the processing time and allowing the processing facility to be at full capacity for more months out of the year;
piling sweet sorghum in a storage pile which optionally excludes most of the foreign material, rocks and dirt;
piling sweet sorghum in a storage pile which allows for the control of the environment within the pile such as temperature and humidity by employing numerous thermocouples located throughout the pile;
piling sweet sorghum in a storage pile employing novel modifications of existing sugar cane technology which will avoid or minimize stalk damage caused by conventional technology;
piling sweet sorghum in a storage pile employing novel modifications of existing sugar cane technology which will avoid or minimize damage to conventional air ducts within the pile caused by conventional technology;
piling sweet sorghum in a storage pile employing novel modifications of existing sugar cane technology which will increase the number of sweet sorghum hauling trucks unloaded per unit time in order to reduce the number of hauling trucks required as compared to conventional sugar cane technology;
piling sweet sorghum in a storage pile employing novel modifications of existing sugar cane technology which will, relative to conventional sugar cane technology, result in less stalk damage and faster stalk piling.

The novel features which are believed to be characteristic of this invention, both as to its organization and method of operation together with further objectives and advantages thereto, will be better understood from the following description considered in connection with the accompanying drawings in which a preferred embodiment of the invention is illustrated by way of example and not limitation.

### BRIEF DESCRIPTION OF THE DRAWINGS

FIG. 1 Illustrates a preferred embodiment of a sweet sorghum whole cane handling, unloading and piling system employing hoists for lifting and positioning the cane, and a cooling system using fans and air pipes to cool the cane with cool ambient air to allow for the storage of sweet sorghum over the winter months.

FIG. 2 Illustrates details of transferring sorghum stalks from the transport cane wagons arriving from the field onto the developing cane storage pile.

FIG. 3 illustrates details of cane grab assemblies.

FIG. 4 illustrates the operations performed on the cane to prevent the deterioration of sugars prior to processing.

### DETAILED DESCRIPTION

A preferred embodiment of a sweet sorghum piling system and method places leaf-stripped whole sweet sorghum stalks onto a storage pile optimized to allow the production of sweet sorghum to ethanol after the harvesting season. In general, the system and method include a crane system for transferring the oriented cane either from the transport wagons or dump pile to the storage pile and a long concrete pathway. An optional preliminary step may be performed to remove any leaves and seed heads that were not removed during harvesting. Leaves and seed heads are detrimental to the storage of cane as they prevent the flow of air through the pile, resulting in spoilage of the cane. An optional cane cleaning device (e.g. a cane cleaning table or vibrating cane conveyor/elevator) can be used which is integrated into the conveying system and receives cane from the field, removes dirt and foreign objects and deposits the cleaned cane in an adjustable orientation onto a platform for piling. As the pile is being constructed, the crane system for elevating the oriented cane is designed to allow for placing the cane at any location along the width of the pile to assist in maintaining an even distribution of cane across the width of the developing sweet sorghum cane storage pile, which in turn minimizes damage to the integrity of the whole stocks. As the pile is being constructed, the crane system for transferring (either from the transport wagons or dump pile) the oriented cane to be placed onto the pile, along with an optional cane cleaning device, are designed in such a manner as to allow for the movement of the equipment the entire length of the pile allowing for the ability to place the cane at any locations along the entire length of the pile. To maintain the proper environment of temperature and humidity inside the sweet sorghum cane pile, an airflow conduit, such as ventilation pipes, for blowing cold air into the finished pile are placed onto the long narrow concrete pathway prior to the building of the storage pile.

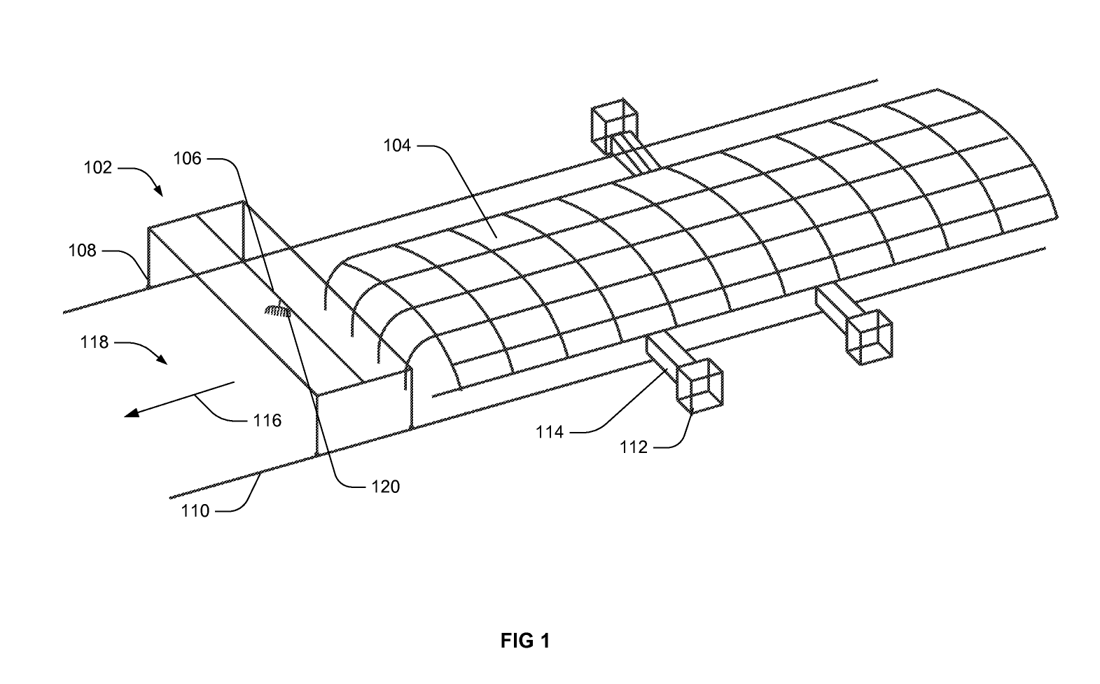

FIG. 1 illustrates a preferred embodiment of a sweet sorghum whole cane handling and storage system. The system comprises a whole cane sweet sorghum handling, unloading and piling system employing hoists 106 for lifting the cane, and a cooling system, such as fans 112 and air pipes 114 to cool the cane. The storage pile of sweet sorghum whole cane 104 allows for the storage of sweet sorghum over the winter months which will allow for a continuous flow of sweet sorghum whole cane from the storage pile to the processing plant. Whole stalk sweet sorghum, with as much of the leaf material and seed heads removed as possible, is considered “cleaned cane” and hereinafter will be referred to as “cane.”

Referring again to FIG. 1, the crane assembly 106 moves along the path of an optional concrete slab which supports the pile and the rails 110 on which a crane moves 116 (direction of travel) with the benefit of wheels 108 at the crane leg-rail interface, leaving in its path a finished cane storage pile 104. A ventilation system includes fans 112 and ventilation pipes 114 resting on the long narrow concrete pathway underneath the finished cane storage pile. The ventilation system 112, 114 blows cold air into the finished cane storage pile to maintain the proper environment of temperature and humidity for storage inside the sweet sorghum cane pile. The pile may be covered for additional protection. Thermocouples are placed at numerous locations throughout the pile to monitor the temperature.

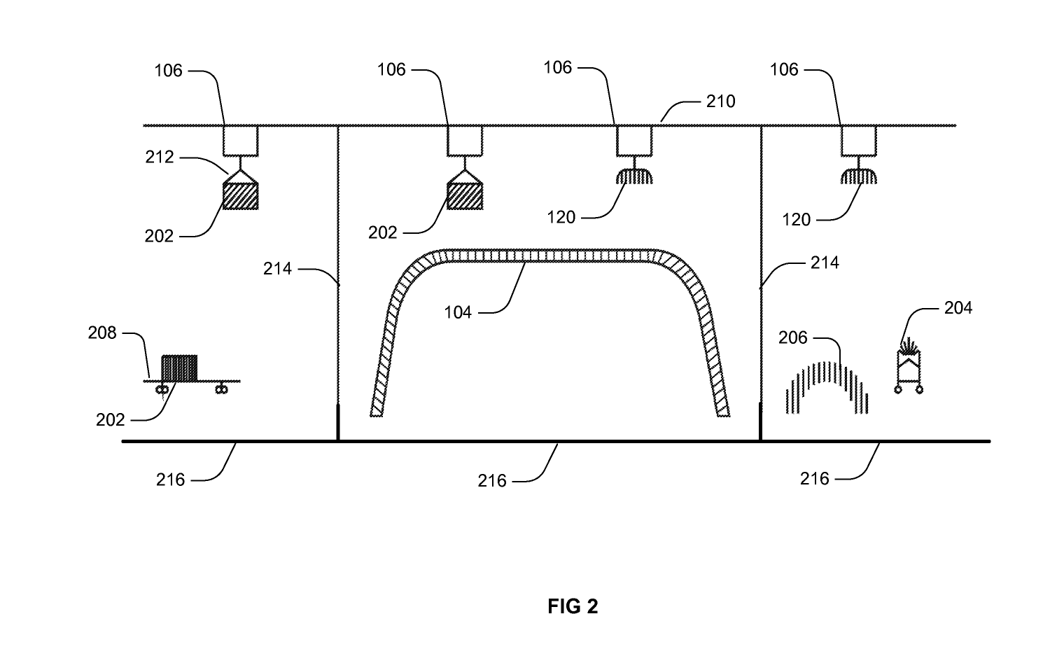

FIG. 2 illustrates an end view of an exemplary cane storage and handling system. As was described above, the storage pile may be built on a concrete slab after being transported from the field and delivered to the piling station in cane bins 202 or cane wagons 204, or other suitable container or transport vehicle or truck. By way of example and not limitation, one option for elevating the cane onto the pile would be to first unload the cane from the cane wagons 204 onto a cane dump pile 206, followed by directly lifting the cane from the cane dump pile 206 with a cane grab 120 or other suitable grabbing mechanism attached to the hoist 106 which can lift the cane from the cane dump pile 206 to an elevation above the pile and horizontally over the developing storage pile using the hoist 106 and trolleys 210, which allows the hoist to run horizontally along rails perpendicular to the crane's direction of travel. Beams on vertical rails 214 provide support for the hoist and crane assembly 106 and 210.

The cane is released and discharged onto the top of the storage pile 104 from the cane grab 120 or other suitable grabbing mechanism by means of a remotely controlled hydraulic or mechanical release mechanism. In this option, several types of cane wagons 204 or transport vehicles 208 can be used to transport the cane from the field to the piling station depending on the type of unloading system which is employed for unloading the cane from the cane wagon 204 or other transport vehicle onto the cane dump pile 206. One example would be to have another separate hoist which could lift a bin 202 sitting on the transport vehicle 208 and tilt the bin sideways to unload the cane from a side releasing bin and onto the storage pile 104. Alternatively, the entire wagon/truck 204 could be tilted so that the cane slides either out the back or out the side of the wagon/truck 204 and onto the storage pile 104. Another example would be to have the wagon/truck 204 drive onto a ramp which raises the height of the wagon/truck 204 so that a latch could release the side door of the wagon/truck 204 which would open and allow the cane to fall out the side of the wagon/truck 204 and onto the dump pile 104 (similar to how coal cars on a train are automatically unloaded).

In another embodiment, elevating the cane onto the storage pile may employ some type of spreader 212 attached to the hoist 106 which allows for the spreader 212 latches to lock on to the cane bin 202 with the spreader 212, allowing the cane bins 202 to be lifted from the truck 208 carrying cane bins 202, or allowing any other suitable container containing the cane to be lifted. In this option, the cane bins 202, or other suitable container containing the cane, are lifted and elevated above the pile and moved horizontally over the developing storage pile 104 using the hoist 106 and trolleys 210, and the cane is released and discharged onto the top of the storage pile 104 from the container by means of a remotely controlled hydraulic or mechanical release mechanism, which opens one or more of the sides or the bottom of the container. Alternatively, the spreader 212 attached to the hoist 106 which allows the cane bins 202, or any other suitable container containing the cane, to be lifted over the storage pile could be replaced by a conveyor system which conveys the containers containing the cane from a location next to the storage pile to a location over the developing storage pile 104 allowing the cane to be released and discharged onto the top of the storage pile 104 from the container by means of a remotely controlled hydraulic or mechanical release mechanism, which opens one or more of the sides or the bottom of the container.

In a third embodiment, elevating the cane onto the storage pile (not shown) may utilize a wagon/truck 204 which would drive onto a ramp spanning the width of the pile so that the wagon/truck 204 drives above the height of the storage pile 104 and a manual or automatic latch could release the side door of the wagon/truck which would open and allow the cane to fall out the side of the wagon/truck and onto the developing storage pile 104.

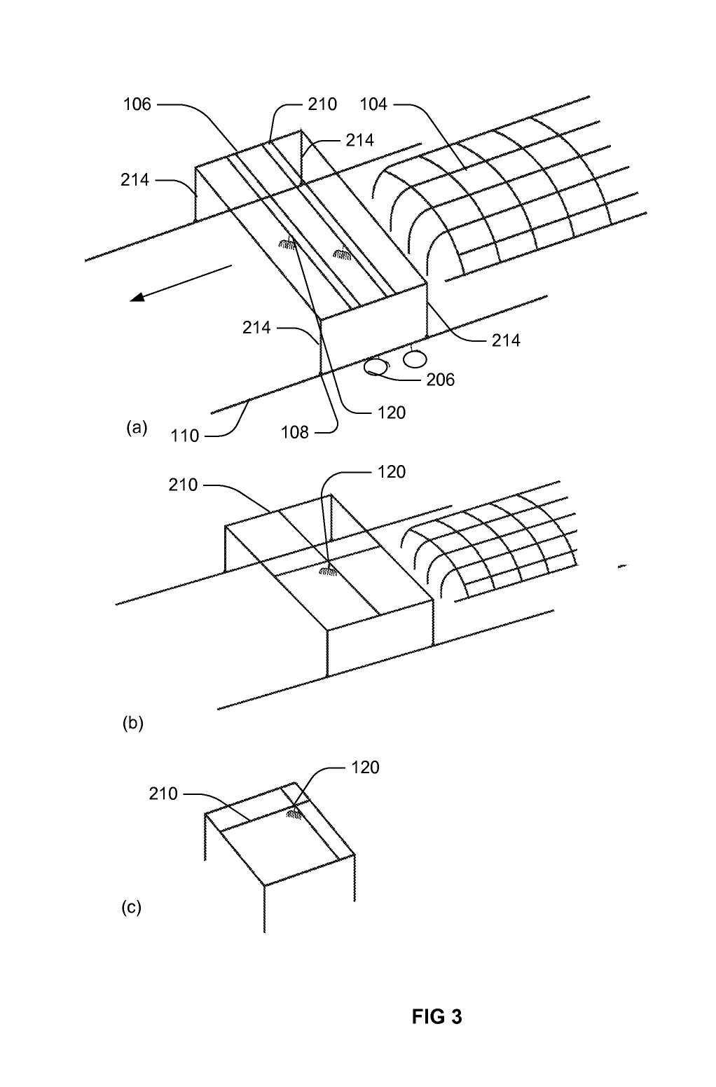

Referring now to FIG. 3(a), horizontal rails 110 to support the crane 106 are laid down on a relatively level section of land approximately one mile long and 400 feet wide, or a square or rectangular section of land of appropriate size to accommodate the storage pile, onto an optional appropriate concrete footing poured to a depth equal to the 100 year frost line, or onto some other appropriate footing to support the weight of the cane and material being lifted. In the case of a storage pile one mile long, the rails 110 would consist of at least two parallel rails in the range of, for example, 150 to 300 feet apart extending to about the length of the pile. In the case of smaller sections of land, such as a square section, a bending or turning system would swing or turn the crane about 180 degrees at the end of each short length pile so that the crane could return on another set of parallel rails to build another short length pile parallel to the previously built short length pile. This process of building short length piles could be repeated any number of times.

FIG. 3 illustrates various configurations of the crane 106, trolley 210 and grab 120 assembly. The crane 106 sits or rides on the rails 110, or on tires on a road next to the pile 104 by means of at least four legs 214, each leg having from one to a multitude of wheels 108 similar to a railroad box car. The crane 106 is moved on the rails 110 by electric motors or other power source, along the entire length of the storage pile 104 as the storage pile 104 is being built. In FIG. 3(a), one superstructure is comprised of two cranes 106 with a trolley 210 and cane grab 120 on each. The trolley allows side to side movement between the legs 214 of the assembly, allowing the cane grab 120 to pick up cane from the dump piles 206 along the side of the rails 110. In FIG. 3(b) the cane grab 120 is positioned in the center of the crane and trolley assembly, with perpendicular trolleys 210. In FIG. 3(c), the cane grab 120 is positioned in one corner of the rectangular assembly 210.

As the height of the storage pile 104 approaches its optimal height, for example, 33 feet, the crane 106 is moved forward in a direction away from the storage pile 104 and repositioned on the rails 110 by means of electric motors or other power source to an area 118 in front of the emerging storage pile 104 so that there is an empty area to accommodate more cane to be piled. The cane piling system moves along the entire length of the rails 118 as the storage pile 104 is being constructed until the length of the storage pile 104 is about the same length as the length of the parallel rails 302 that the traveling crane 106 moves on.

While the storage pile 104 is being built, and prior to cane being discharged onto the ground in front of the storage pile 118, optional air pipes 114 are laid down on the ground with a distance between air pipes 114 such that a sufficient amount of air can be ventilated through out the pile to cool the pile temperature to the required storage temperature, or other suitable air conducting mechanism can be used for delivering cool ambient air into the storage pile 104. Ideally, the air pipes or other suitable air conducting mechanism will be very close to the bottom of the storage pile 104, although air pipes or other suitable air conducting mechanism may be placed at other locations in the pile for better circulation of cool ambient air. After the cane is piled, electric fans 112 are attached to the air pipes 114, or other suitable air conducting mechanism, and when the ambient air temp drops below about 40 degrees Fahrenheit, cool air can be forced into the pile by means of the electric fans 112 or other cooling device, to either cool the cane to a temperature closer to 32 degrees Fahrenheit, or freeze the sweet sorghum cane at a temperature below 32 degrees Fahrenheit. Thermocouples are placed at numerous locations throughout the pile to monitor the temperature.

A reasonable storage pile size is believed to be 33 feet high and 165 feet wide along the length of the optional concrete pathway. The size of the pile is similar to the size of a sugar beet pile and therefore the cooling fans and air pipes that are commercially available are designed to work with this size storage pile, as the air back pressure in the air pipes and the weight of the pile on the air pipes should be similar for same size sorghum and sugar beet piles. This assumes the airflow resistance of air being forced through the pile by the fans is the same for sugar beet and sweet sorghum piles, although this has never been measured. The height of the pile may also be limited by the weight of the pile on the sorghum stalks on the bottom of the pile, which may become damaged when the weight above it becomes too great. This exposes the sugars inside to microbes which will destroy/metabolize the sugar, and which will also crush the stalks and close the air gaps in the pile, which are necessary for circulation of cool air for cooling, with out which the cane will increase metabolism and use up the sugars

The length of the pile may be as long as desired. It will not make a difference on how the sorghum stores, although having many shorter piles parallel to each other would make more sense than having one extremely long pile.

Because the sorghum within the first 1 to 2 feet of the surface of the storage pile generally does not store very well, if at all, the higher the pile the less influence the surface sorghum will have. But the higher the pile, the more weight on the sorghum at the bottom of the pile which will crush and damage the sorghum stalks which will (1) decrease the sorghum stalk ability to store the sugars contained in the stalks, and (2) eliminate the air spaces between the stalks so that air flow for cooling which is being pumped into the pile through the air pipes by the fans will be stopped. This can cause the pile to start heating up and thus cause the stalk metabolism to increase which will use up the stalk sugars. Additionally, stalk sugar will be lost to microbial action. Therefore, 33 feet is a reasonable starting point for storage pile height, although after many years of practice and research it will become evident what the optimum height should be.

Regarding the width of the storage pile, it is necessary to keep the pile cool at about 32 deg F. for storage of the stalk sugars, but if the temperature in the pile starts to rise (maybe from lack of air flow), access may be required to remove the heating sorghum so it can be sent to the plant for processing before the sugars are completely depleted. A pile of 165 feet width allows the middle of the pile to be removed if desired. With a wider pile, removal of the cane from the center of the pile becomes more difficult. Also, the width of the pile is limited by the crane system since the two sides of the crane can only be so far apart before center supports are required, and this would interrupt the building of the pile. Therefore, 165 feet is a reasonable starting point to use for a width, although after many years of practice and research it will become evident what the optimum width should be.

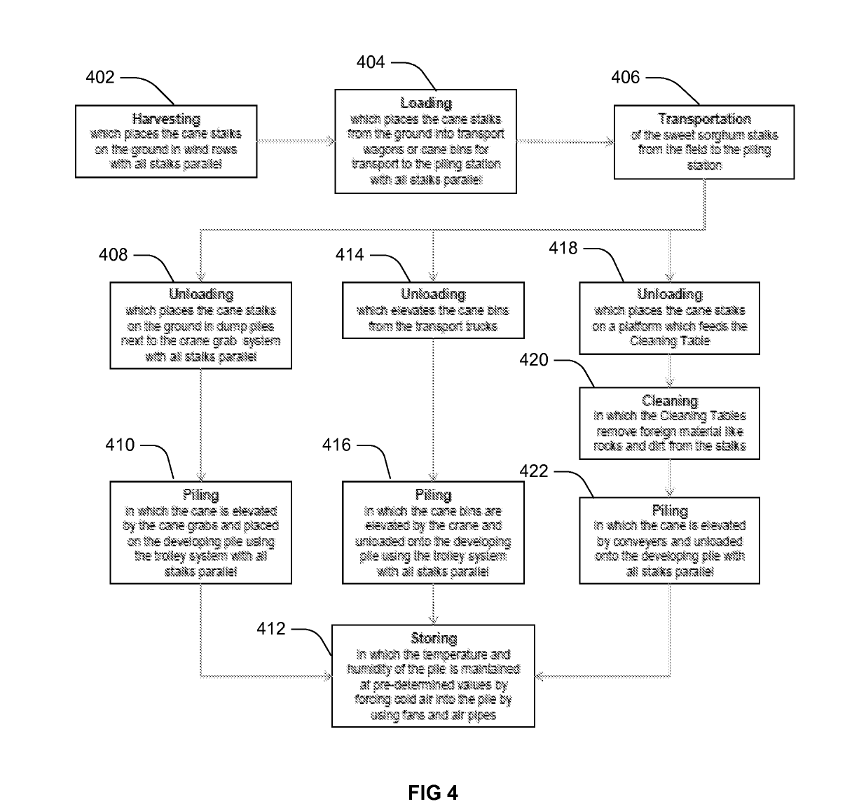

FIG. 4 provides an overview of the processes and operations that can be performed to store the cane in a manner that will prevent the deterioration of sugars prior to processing. These various paths to storage are offered by way of example and not limitation, as there are many ways to unload and pile the cane. The cane is harvested 402, during which the cane stalks are placed on the ground in wind rows with all stalks parallel. The cane may be loaded 404 from the ground into transport wagons or cane bins for transport to the piling station with all stalks parallel. The cane may then be transported 406 from the field to the piling station. At the piling station, several different processes may occur. In one path 408, cane is unloaded, and the stalks are placed on the ground in dump piles next to the crane grab system with all stalks parallel. Then the cane may be elevated by the cane grabs 410 and placed on the developing pile using the trolley system with all stalks in parallel. Cane is stored 412 on the pile, while the temperature and humidity of the pile is maintained at pre-determined values (and measured by the use of implanted thermocouples) by forcing cold air into the pile by using fans and air pipes. In a second path 414, cane may be placed in bins and elevated from the transport trucks, placed in bins, elevated by the crane and unloaded 416 onto the developing pile using the trolley system with all stalks parallel, and then placed on the pile 412 as described above. In a third path 418, the cane is unloaded and the stalks are placed on a platform which feeds the cleaning table. Cleaning 420 removes foreign materials like rocks and dirt from the stalks. The cane may be piled 422 by elevating the cane by conveyors and unloading onto the developing pile with all stalks parallel and stored 412 as described above.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. A system for storing cane to prevent the deterioration of sugars, comprising:
a concrete base;
a plurality of airflow conduits positioned on top of the concrete base with aeration openings therein to allow air to flow inward through the conduit;
a fan providing air flow into the conduit;
a crane and trolley system comprising cane grabs for lifting and distributing cane on the concrete base over the airflow conduits;

2. The system for storing cane to prevent the deterioration of sugars of claim 4, further comprising a cover for the cane pile.

3. The system of storing cane to prevent the deterioration of sugars of claim 4, further comprising a cleaning device to prepare cane for storage by removing foreign objects.
